(19) United States
(12) Patent Application Publication
(10) Pub. No.: US 2026/0336347 A1
(43) Pub. Date: Oct. 29, 2026

(54) Fastening Arrangement of a Spring Element and/or Damper Element on a Body of a Motor Vehicle, and Method for Fastening Such a Spring Element and/or Damper Element

(71) Applicant: Bayerische Motoren Werke Aktiengesellschaft, Muenchen (DE)

(72) Inventors: Malte FLAKE, Pfaffenhofen a.d.Ilm (DE); Michael LEHNER, Olching (DE); Tatjana SCHOIERER, Haimhausen (DE); Mike STEINBOCK, Scheuring (DE)

(21) Appl. No.: 19/122,374

(22) PCT Filed: Sep. 15, 2023
(86) PCT No.: PCT/EP2023/075447

§ 371 Date: Apr. 18, 2025

(30) Foreign Application Priority Data
Oct. 19, 2022 (DE) 10 2022 127 435.7

(51) Int. Cl. B60G 15/06; B60G 11/00; B60G 13/00; B62D 25/08; B62D 65/12

(52) U.S. Cl. CPC B60G 15/067; B60G 11/00; B60G 13/003; B62D 25/088; B62D 65/12; B60G 2204/128

(57) ABSTRACT

A fastening arrangement on a body of a motor vehicle includes a spring element and/or a damper element where the spring element and/or the damper element is fastened on the body. The spring element and/or the damper element has a positioning element which has an outer circumferential casing surface that widens from top to bottom in a height direction of the motor vehicle. The positioning element engages in a recess of a body element of the body such that the outer circumferential casing surface of the positioning element is supported at least on a part region of an inner contour of the recess.

### BACKGROUND AND SUMMARY

The invention concerns a fastening arrangement of a spring element and/or damper element on a body of a motor vehicle, in particular a passenger vehicle. The invention furthermore concerns a method for fastening a spring element and/or damper element on a body of a motor vehicle, in particular a passenger vehicle.

DE 10 2012 113 161 A1 discloses a spring strut suspension reinforcing unit of a vehicle, with a shock absorber housing cover in which a spring strut is inserted. Furthermore, DE 10 2021 113 350 A1 discloses a motor vehicle with a spring strut.

It is an object of the present invention to provide a fastening arrangement of a spring element and/or damper element on a body of a motor vehicle, in particular a passenger vehicle, and a method for fastening a spring element and/or damper element on a body of a motor vehicle, in particular a passenger vehicle, so that a particularly advantageous mounting of the spring element and/or damper element on the body can be implemented.

A first aspect of the invention concerns a fastening arrangement of a spring element and/or damper element on a body of a motor vehicle, which is also simply called a vehicle and which can preferably be configured as a passenger vehicle, and quite particularly preferably as a car. In particular, the motor vehicle is a passenger vehicle, the interior of which (also called the passenger cell or passenger compartment) is formed or defined by the body, which is preferably configured as a self-supporting body and also called a superstructure. In the fastening arrangement, the spring element and/or damper element is fastened on the body. Via the spring element and/or damper element, for example at least one or precisely one vehicle wheel of the motor vehicle, simply also called a wheel, is or can be supported on the body in sprung and/or damped fashion, in particular in the vehicle height direction of the motor vehicle. The vehicle wheel is a ground contact element of the motor vehicle, which is or can be supported on a ground via the ground contact element, downwards in the vehicle height direction. When the motor vehicle travels along the ground while the motor vehicle is supported on the ground via the ground contact element, downwards in the vehicle height direction of the motor vehicle, the vehicle wheel rolls along on the ground, in particular directly. It is possible that the spring element and/or damper element, simply also called the element, has at least one or precisely one spring element, via which the vehicle wheel is or can be supported on the superstructure (on the body) in sprung fashion. The spring element may be a mechanical spring, such as for example a coil spring, or however an air spring. Alternatively or additionally, the spring element and/or damper element may have an in particular hydraulic vibration damper, which is also known as a shock absorber. By means of the vibration damper, relative movements between the vehicle wheel and the body, which in particular take place in the vehicle height direction, can be damped. It is conceivable that the spring element and/or damper element is configured solely as a spring device or as a spring element, and in this case is free of a hydraulic vibration damper. It is furthermore conceivable that the spring element and/or damper element is configured solely as a vibration damper, thus as a damper element, and is therefore free of a spring element for sprung support of the vehicle wheel on the body. The spring element and/or damper element may be configured as a spring strut which comprises a spring element, such as for example the above-mentioned spring element, and a vibration damper, such as for example the above-mentioned vibration damper, wherein for example the spring element and the vibration damper are arranged coaxially to one another. It is furthermore conceivable that the spring element and/or damper element has a spring element, such as for example the above-mentioned spring element, and a hydraulic vibration damper, which are not however arranged coaxially to one another but may be arranged axially offset from one another.

In order now to be able to implement a particularly advantageous mounting, in particular a particularly simple mounting which is thus favorable in terms of time and cost, and hence a fastening of the spring element and/or damper element (element) on the body, it is provided according to the invention that the spring element and/or damper element has in particular at least one, or precisely one, positioning element which has an outer circumferential casing surface widening from top to bottom in the vehicle height direction. It is here provided in particular that the outer circumferential casing surface is formed conically, so that on the outer circumference, the positioning element is formed conically or tapering. This means that the outer circumferential casing surface, or outer circumference of the positioning element, has the form of a cone, i.e., the form of at least part of a cone, so that the outer circumferential casing surface is for example congruent with at least a part of a theoretical cone, which widens from top to bottom viewed in the vehicle height direction. For example, the conical outer circumferential casing surface of the positioning element, viewed upwards in the vehicle height direction, ends at a tip or forming a tip, so that for example the positioning element is also called a centering tip or positioning tip. This will be explained in more detail below.

Furthermore, according to the invention, it is provided that a body element of the body, also called a body component, has a recess which is configured for example as a passage opening that is continuous in the vehicle height direction. Here, the positioning element, in particular the conical or tapering outer circumferential casing surface of the positioning element, engages in the recess such that the outer circumferential casing surface of the positioning element, i.e., at least a part of the conical outer circumferential casing surface of the positioning element, is supported, in particular directly, at least on a part region of an inner contour of the recess. The recess is also called an opening or is configured as an opening. Because the outer circumferential casing surface of the positioning element is conical, i.e., runs or is configured in the form of a cone, and because the outer circumferential casing surface of the positioning element is supported, in particular directly, at least on the part region of the inner contour of the recess, the spring element and/or damper element can be oriented, i.e., positioned and in particular centered, relative to the body particularly easily (and hence favorably in terms of time and cost) and particularly precisely via the positioning element and the recess, in particular the inner contour.

For example, during a production of the motor vehicle, a process is performed which is also known as marriage. During the marriage, for example a vehicle axle—also described as an axle—of the motor vehicle, comprising the spring element and/or damper element, is connected to the body, wherein in particular the spring element and/or damper element is fastened on the body and hence connected to the body. In this process, i.e., during marriage, now the spring element and/or damper element can be oriented (and hence positioned), in particular centered, relative to the body easily and precisely by means of the positioning element and by means of the recess, so that a particularly simple mounting—which in particular can be performed favorably in terms of time and cost—of the spring element and/or damper element and hence of the axle as a whole is conceivable. In particular, the recess, in particular its inner contour, may serve as a body-side catchment contour, by means of which the spring element and/or damper element can be oriented relative to the body easily and precisely, in particular via the positioning element, in particular on or during the marriage. In particular, for example, the positioning element may be used as or function as a joining tip, in order to position the spring element and/or damper element relative to the body in a relative movement, taking place in particular purely in the vehicle height direction, between the spring element and/or damper element and the body. The relative movement, taking place in particular during the marriage, between the spring element and/or damper element and the body, is performed for example by means of at least one handling device, wherein now, because of the invention, it is possible to position the spring element and/or damper element relative to the body by means of the positioning element and by means of the recess, in particular during this relative movement, taking place in the vehicle height direction, between the spring element and/or damper element and the body, without an additional external intervention being required, i.e., without for example using or needing to use a device, provided additionally to the handling device, in order to orient, i.e., position, the spring element and/or damper element relative to the body. The invention allows the spring element and/or damper element, in particular on or during the marriage, to be oriented relative to the body particularly easily and precisely even when, for example, initially an actual position of the spring element and/or damper element relative to the body deviates greatly from a nominal position or mounting position, in which for example the spring element and/or damper element is situated after its fastening or mounting on the body. The invention here allows the advantageously simple and precise orientation of the spring element and/or damper element relative to the body in a pure z movement, i.e., in a relative movement between the spring element and/or damper element and the body which takes place purely in the vehicle height direction, wherein this relative movement takes place on or during the marriage and for example is carried out by or provoked by the handling device, also called a handling machine or handling apparatus.

In order to be able to orient the spring element and/or damper element relative to the body particularly easily and precisely, and hence mount the spring element and/or damper element particularly easily (and hence favorably in terms of time and cost), in an embodiment of the invention, it is provided that the positioning element is deformed, in particular elastically deformed, because the outer circumferential casing surface is supported, in particular directly, on at least a part region of the inner contour. In this way, a defined orientation or positioning of the spring element and/or damper element relative to the body can be guaranteed. In particular, it is thereby possible to avoid undesired relative movements, occurring in particular during the marriage, between the spring element and/or damper element and the body, in particular in that it is possible to avoid that the spring element and/or damper element, during the marriage, comes too close to the body or comes into undesired contact with the body, without complex and additional measures being required for this.

A further embodiment is distinguished in that the recess has a first region, which is at least partially delimited by the above-mentioned part region of the inner contour, the part region of which is also known as first part region or is a first part region. The recess also has a second region, which is delimited, in particular directly, by a second part region of the inner contour of the recess, which adjoins, in particular directly, the first part region of the inner contour. In particular, the regions of the recess are connected together, which should be understood to mean that the regions of the recess transform into one another without interruption and hence continuously. Again expressed in other words, the regions of the recess transform into one another without the regions of the recess being separated from one another by a wall of the body.

It is furthermore provided that the spring element and/or damper element is to be detached, in particular non-destructively, from the body and is then movable relative to the body, in particular at least in a movement plane spanned by the vehicle longitudinal direction and the vehicle transverse direction of the motor vehicle, such that the positioning element, while the positioning element engages in the recess, is displaceable from the first region into the second region of the recess, in particular in the movement plane, and then is movable out of the recess downwards in the vehicle height direction. By the movement of the positioning element from the first region into the second region, the elastic deformation of the positioning element can be or is eliminated. This is made possible in particular because the first region, in particular when considered alone, has a first dimension, in particular a first inner circumference, wherein the second region has a second dimension, in particular a second inner circumference, wherein the second dimension or the second inner circumference is larger than the first dimension or the first inner circumference, such that by moving or arranging the positioning element into or in the second region, a deformation of the positioning element does not occur, or such that by moving the positioning element from the first region into the second region, the elastic deformation of the positioning element is eliminated, in particular with the same or constant position or positioning of the positioning element relative to the body. The first region is thus a rough region or a first rough catchment region, wherein the second region is for example a fine region or a second fine catchment region. By means of the rough region, for example during mounting, in particular during the marriage, the spring element and/or damper element can be roughly pre-positioned relative to the body. Then, for example, the positioning element can be moved from the second region into the first region, whereby a fine orientation of the spring element and/or damper element relative to the body takes place via the positioning element, and the positioning element is deformed, in particular elastically. In particular, for example, the first dimension, in particular the first inner circumference, is formed, in particular directly, by the first part region of the inner contour, and for example the second dimension, in particular the second inner circumference, is formed or delimited, in particular directly, by the second part region of the inner contour. With this embodiment, it is for example also possible to make the mounting of the spring element and/or damper element at least partly reversible, in particular if a fault has occurred. For this, the spring element and/or damper element is moved relative to the body such that the positioning element is moved out of the first region into the second region, whereby the elastic deformation of the positioning element is eliminated. Then the positioning element can be moved relative to the body downwards in the vehicle height direction, and hence moved out of the recess. The feature that the spring element and/or damper element can be detached, thus is detachable, from the body non-destructively, means that the spring element and/or damper element can be detached from the body without any destruction or damage to the body or spring element and/or damper element. Thus the mounting can be carried out particularly easily and hence favorably in terms of time and cost.

The spring element and/or damper element is a first structural element or is also called a first structural element. The body is a second structural element or is also called a second structural element. Here, it has proved particularly advantageous if one of the structural elements, in particular the body, has an outer circumferential, conical second positioning element, which is provided in addition to the positioning element, also called the first positioning element, and spaced apart from the first positioning element. The other structural element, in particular the spring element and/or damper element, has a receiver which is provided in addition to the recess and spaced apart from the recess, and in which the second positioning element engages. By means of the second positioning element and by means of the receiver, a particularly simple and precise orientation, i.e., positioning of the spring element and/or damper element relative to the body, can be implemented, in particular because the spring element and/or damper element and the body are moved relative to one another such that the second positioning element is moved, in particular inserted, into the receiver. Thereby, for example, the spring element and/or damper element can be oriented relative to the body in a simple and precise fashion, in the vehicle longitudinal direction (x direction) of the motor vehicle. The second positioning element is, for example, moved into the receiver by the movement, in particular displacement, of the positioning element out of the second region into the first region. Thus it is preferably provided that the movement of the second positioning element into the corresponding receiver is accompanied simultaneously by the movement of the first positioning element out of the second region into the first region.

In particular, the second positioning element engages in the receiver, for example, such that a conical second outer circumferential casing surface of the second positioning element is supported, in particular directly, on an inner circumferential casing surface, which directly delimits the receiver, of the other structural element. Thus a precise positioning of the spring element and/or damper element relative to the body can be provided in a simple fashion.

In order to be able to orient the spring element and/or damper element relative to the body particularly easily and precisely, in a further embodiment of the invention, it is provided that the second positioning element is formed conically with respect to a cone axis which runs obliquely or perpendicularly to the vehicle height direction. For example, the cone axis runs in the vehicle transverse direction (y direction) of the motor vehicle. The feature that the second positioning element is formed conically with respect to a cone axis, means in particular that the conical second outer circumferential casing surface of the second positioning element coincides at least with a part of a theoretical second cone, which is formed rotationally symmetrical relative to the cone axis. As a result, the spring element and/or damper element can be oriented relative to the body in a particularly simple and precise fashion, in particular by the movement of the spring element and/or damper element and the body relative to one another along the cone axis, whereby the second positioning element is moved into the receiver.

In order to be able to implement a particularly simple fastening, hence favorable in terms of time and cost, of the spring element and/or damper element to the body, in a further embodiment of the invention, it is provided that the spring element and/or damper element is screwed to the body in a screwing direction and thereby fastened on the body. The screwing direction in particular means the following: the spring element and/or damper element is screwed to the body in the screwing direction by means of at least one screw element, and thereby fastened on the body. In order to screw the spring element and/or damper element to the body by means of the screw element, the screw element is rotated about the straight screwing direction relative to the body and relative to the spring element and/or damper element, whereby the screw element is screwed in particular to a corresponding further screw element. For example, the screw element may be a bolt. By screwing the screw element, i.e., by turning the screw element about the screwing direction, that is to say about a screw axis coinciding with the screwing direction, relative to the spring element and/or damper element and the body, the screw element is moved in the screwing direction relative to the body and/or relative to the spring element and/or damper element, in particular because the rotation of the screw element, taking place about the screwing direction or about the screw axis, is converted by means of corresponding thread into a translational movement of the screw element, taking place in the screwing direction or along the screw axis.

Here, to implement a mounting of the spring element and/or damper element which can be performed particularly easily and hence favorably in terms of time and cost, it has proved particularly advantageous if the screwing direction runs perpendicularly to a plane, called a screwing plane, which runs parallel to the vehicle height direction (z direction) of the motor vehicle. Alternatively or additionally, the screwing direction encloses an angle with the vehicle height direction and/or with the vehicle longitudinal direction of the motor vehicle, which angle is greater than 70°, in particular greater than 80°, and quite particularly amounts to 80°. The angle here is the smallest angle which the screwing direction encloses with the vehicle height direction or the vehicle longitudinal direction. Furthermore, it is preferably provided that the screwing direction encloses an angle with the vehicle transverse direction (y direction) of the motor vehicle, which angle amounts at most to twenty degrees, in particular at most ten degrees, wherein the angle between the screwing direction and the vehicle transverse direction means the smallest angle between the screwing direction and the vehicle transverse direction. Alternatively or additionally, it is provided that the screwing direction runs in the vehicle transverse direction of the motor vehicle, hence parallel to the vehicle transverse direction, whereby the spring element and/or damper element can be fastened on the body in a particularly simple fashion, which is hence favorable in terms of time and cost.

For example, the spring element and/or damper element is connected to the body by means of a connecting tool and thereby fastened on the body. For example, the connecting tool may be a screwing tool, by means of which, for example, the screw element is rotated about the screwing direction, i.e., about the screw axis, relative to the spring element and/or damper element and relative to the body, in order thereby to screw the spring element and/or damper element to the body and hence fasten it on the body. For example, the connecting tool exerts a force on the spring element and/or damper element, wherein the force runs along the screw axis. By means of the force, for example, the spring element and/or damper element is moved along the screwing direction or along the screw axis, in particular relative to the body, and/or such that the positioning element is moved out of the second region into the first region, while the positioning element engages in the recess. This takes place for example during and/or after the marriage. Thus a particularly simple positioning, which can be executed favorably in terms of time and cost, of the spring element and/or damper element relative to the body can be implemented, in particular without having to use devices provided in addition to the connecting tool and in addition to the handling device.

Here, it has proved particularly advantageous if the cone axis runs parallel to the screwing direction or coincides with the screwing direction, so that a particularly simple positioning, which can be executed favorably in terms of time and cost, of the spring element and/or damper element relative to the body is feasible. This takes place in particular such that, by means of the connecting tool, this force is exerted on the spring element and/or damper element, in order thereby firstly to move the positioning element out of the second region into the first region, and secondly to move the second positioning element into the corresponding receiver, whereupon, for example by means of the connecting element, the spring element and/or damper element can be fastened on the body, in particular the screw element can be screwed. Thus the mounting of the spring element and/or damper element can be carried out particularly favorably in terms of time and cost.

A second aspect of the invention concerns a method for fastening a spring element and/or damper element on a body of a motor vehicle. In particular, by means of the method, a fastening arrangement according to the first aspect of the invention is produced. In the method, the spring element and/or damper element is fastened on the body.

In order to be able to fasten the spring element and/or damper element on the body particularly favorably in terms of time and cost, in the second aspect of the invention, it is provided that the spring element and/or damper element has a positioning element, which has an outer circumferential casing surface widening from top to bottom in the vehicle height direction, and which is moved into a recess of a body element of the body, whereby the positioning element is moved into engagement with the recess such that the outer circumferential casing surface is supported, in particular directly, at least on a part region of an inner contour of the recess. Advantages and advantageous embodiments of the first aspect of the invention should be regarded as advantages and advantageous embodiments of the second aspect of the invention, and vice versa.

In order to be able to orient the spring element and/or damper element relative to the body in a particularly simple and precise fashion, in an embodiment of the second aspect of the invention, it is provided that the recess has a first region which is at least partially delimited by the part region as the first region of the inner contour. The recess also has a second region which is delimited by a second part region, adjoining the first part region of the inner contour, of the inner contour of the recess. Here, the positioning element is initially moved, in particular inserted, into the second region from bottom to top in the vehicle height direction, and then, while the positioning element engages in the recess, is moved from the second region into the first region at least in a movement plane spanned by the vehicle transverse direction and the vehicle longitudinal direction, whereby the outer circumferential casing surface of the positioning element is brought into—in particular direct—support contact with the first part region, which at least partially delimits the first region, of the inner contour, and the positioning element is deformed, in particular elastically. This means in particular that the positioning element must be deformed, in particular elastically, in order to move or be able to move the positioning element out of or from the second region into the first region. Thus for example, in particular during the marriage, and hence in particular on a relative movement between the spring element and/or damper element or the body which takes place in the vehicle height direction, it can be avoided that the spring element and/or damper element comes undesirably close to the body or even undesirably collides with the body. After, and for example only after, the positioning element has been moved into the second region, the positioning element is or can be moved from the second region into the first region, for which the—in particular elastic—deformation of the positioning element is necessary. Thus, the spring element and/or damper element can be positioned precisely and as required relative to the body.

Further details of the invention arise from the following description of a preferred exemplary embodiment with the associated drawings.

### BRIEF DESCRIPTION OF THE DRAWINGS

FIG. 1 shows in extract a schematic, perspective view of a fastening arrangement of a spring element and/or damper element on a body of a motor vehicle;

FIG. 2 shows in extract a further schematic, perspective view of the fastening arrangement;

FIG. 3 shows in extract a schematic and partly sectional, further perspective view of the fastening arrangement;

FIG. 4 shows in extract a further schematic, perspective view of the fastening arrangement;

FIG. 5 shows in extract a further schematic, perspective view of the fastening arrangement;

FIG. 6 shows in extract a further schematic and partly sectional, perspective view of the fastening arrangement; and

FIG. 7 shows in extract a further schematic, perspective view of the fastening arrangement.

### DETAILED DESCRIPTION OF THE DRAWINGS

In the figures, the same elements or those with equivalent function carry the same reference signs.

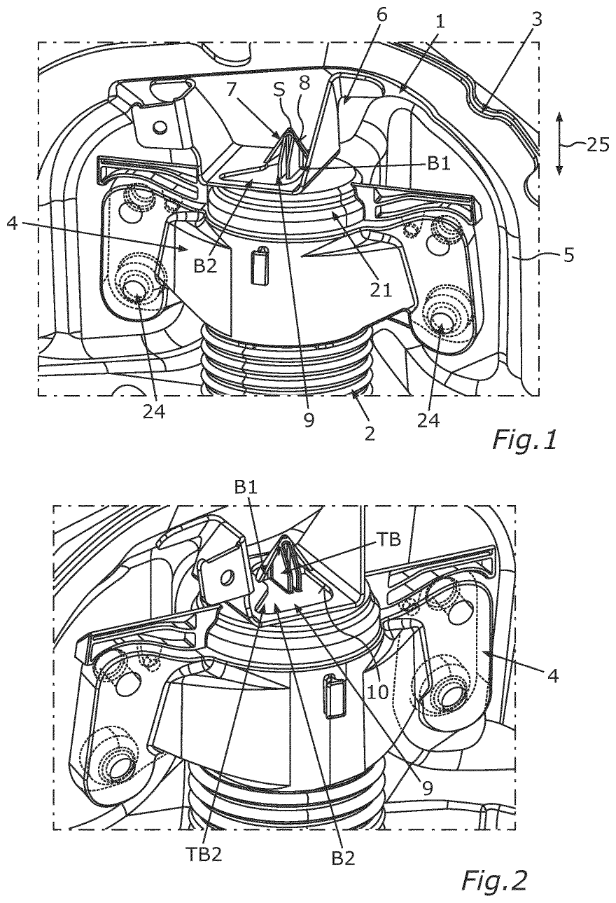

FIG. 1 shows in extract, in a schematic perspective view, a fastening arrangement 1 of a spring element and/or damper element 2 on a body 3 of a motor vehicle, which is also simply called a vehicle. In the exemplary embodiment shown in the figures, the motor vehicle is configured as a passenger vehicle, in particular a car, the interior of which (also called the passenger cell or passenger compartment) is formed by the body 3. Here, the body 3 is configured as a self-supporting body. In the exemplary embodiment shown in the figures, the spring element and/or damper element 2 is configured purely as a damper element, which is free from a spring element and in the present case is configured as a hydraulic vibration damper. The vibration damper is also called a shock absorber. In fully manufactured state of the motor vehicle, at least one or precisely one vehicle wheel is supported on the body 3 in damped fashion via the vibration damper. The feature that the spring element and/or damper element 2 is free from a spring element, means that the spring element and/or damper element is free from a spring element, via which the vehicle wheel is supported on the body 3 in sprung fashion.

In the fastening arrangement 1, the spring element and/or damper element 2—which is also simply called an element—has a fastening element which, in the present case, is configured as a support bearing 4 or is also called a support bearing. Via the support bearing 4, with the fastening arrangement 1, the spring element and/or damper element 2 is fastened on the body 3 such that the support bearing 4 is fastened on the body 3. For this, the body 3 has a first body element 5 on which the support bearing 4 is fastened. As will be explained in more detail below, the support bearing 4—and therefore, via the support bearing 4, the spring element and/or damper element 2—is screwed to the first body element 5 and hence to the body 3, and thus fastened on the body element 5 and hence on the body 3, and thus screwed onto the body element 5 and hence onto the body 3. The body 3 also has a second body element 6. It is conceivable that the body elements 5 and 6 are formed separately from one another and connected to one another, in particular such that the body elements 5 and 6 are welded together and/or bonded together and/or riveted together and/or otherwise connected to one another.

In order now to be able to mount, and thus fasten, the spring element and/or damper element 2 on the body 3 in a particularly simple fashion, which is hence favorable in terms of time and cost (thus, to produce the fastening arrangement 1 in a fashion which is particularly favorable in terms of time and cost), the spring element and/or damper element 2 has a first positioning element 7. The positioning element 7 has an outer circumferential casing surface 8 which widens from top to bottom in the vehicle height direction of the motor vehicle. The vehicle height direction of the motor vehicle is also called z or the z direction, and is illustrated in FIG. 1 by a double arrow 25. In the exemplary embodiment shown in the figures, the positioning element 7, i.e., its outer circumferential casing surface 8, is formed conically i.e., tapering, so that the outer circumferential casing surface 8 runs along at least a part of a theoretical first cone, also called the first cone, the cone axis of which—relative to which the first cone is formed for example rotationally symmetrical—runs in the vehicle height direction. In the exemplary embodiments shown in the figures, the outer circumferential casing surface 8 has a tip S pointing upwards in the vehicle height direction, so that the first positioning element 7 is also called the positioning tip or centering tip.

Furthermore, it is provided that the body element 6 of the body 3 has a recess 9 which, in the present case, is formed as a passage opening which is continuous in the vehicle height direction of the motor vehicle, and is therefore also called an opening. This means, in particular, that the recess 9 passes completely through the body element 6 in the vehicle height direction. In particular, the recess 9 extends in an extent plane which is spanned by the vehicle transverse direction of the motor vehicle and by the vehicle longitudinal direction of the motor vehicle. The vehicle longitudinal direction is also called x or the x direction, and the vehicle transverse direction is also called y or the y direction, wherein the vehicle transverse direction and the vehicle longitudinal direction run perpendicularly to one another and in each case perpendicularly to the vehicle height direction. It is particularly clear from FIGS. 1 and 2 that the positioning element 7, in particular the outer circumferential casing surface 8 of the positioning element 7, engages in the recess 9, such that the outer circumferential casing surface 8 of the positioning element 7 is supported directly at least on a part region TB of an inner contour 10 of the recess 9. The inner contour 10 of the recess 9 is formed by an inner circumferential casing surface of the body element 6, the inner circumferential casing surface of which in particular completely surrounds and/or directly delimits the recess 9. The part region TB is also called a first part region of the inner contour 10. In particular, it is provided that the positioning element 7 is not overlapped downwards in the vehicle height direction by the body element 6, so that preferably there is no support of the positioning element 7 on the body element 6, downwards in the vehicle height direction.

Because the outer circumferential casing surface 8 is supported at least on the first part region TB of the inner contour 10, the positioning element 7 is deformed, in particular elastically deformed. In particular, it is provided that the outer circumferential casing surface 8 is supported, in particular exclusively, on the inner contour 10, i.e., on the first part region TB, in the radial direction of the cone, the radial direction of which runs perpendicularly to the cone axis. It is particularly evident from FIGS. 1 and 2 that the recess 9 has a first part region B1, which is delimited, in particular directly, at least partially by the first part region TB of the inner contour 10 of the recess 9. The recess 9 also has a second region B2, which is delimited, in particular directly, by a second part region TB2 of the inner contour 10 of the recess 9, which adjoins, in particular directly, the first part region TB of the inner contour 10. The spring element and/or damper element 2 is fastened on the body 3 so as to be detachable without destruction, and can be detached from the body 3 non-destructively and then moved relative to the body 3, such that the positioning element 7, while the positioning element 7 engages in the recess, can be displaced from the first region B1 into the second region B2 of the recess 9, in particular in a movement plane. Preferably, the movement plane is spanned by the vehicle transverse direction of the motor vehicle and by the vehicle longitudinal direction of the motor vehicle, and thus coincides for example with the extent plane. By displacement of the positioning element 7 out of the first region B1 into the second region B2, the elastic deformation of the positioning element 7 is eliminated, and after the positioning element 7 has been displaced from the first region B1 into the second region B2, the positioning element 7 can be moved relative to the body 3 downwards in the vehicle height direction, and thereby moved out of the recess 9; thus, after the positioning element 7 has been displaced from the region B1 into the region B2, the positioning element 7 can be moved out of the recess 9, in particular downwards in the vehicle height direction of the motor vehicle, such that a relative movement between the body 3 and the spring element and/or damper element 2, and hence the positioning element 7, takes place in the vehicle height direction.

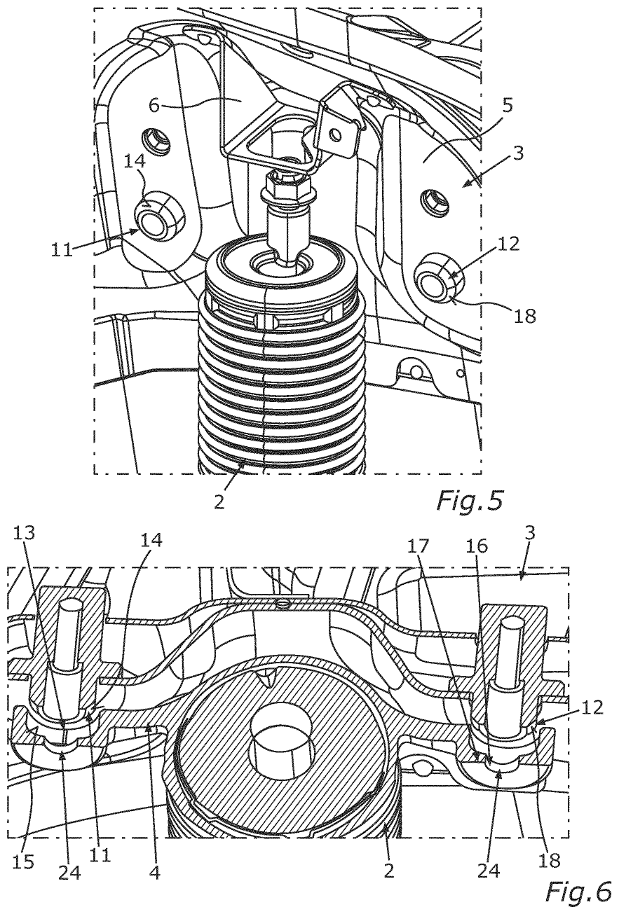

A combined view of FIGS. 1 to 7 shows that the spring element and/or damper element 2 is a first structural element or also called a first structural element, wherein the body 3 is a second structural element or also called a second structural element. Here, one of the structural elements, in the present case the body 3, has an outer circumferential, conical second positioning element 11, which is provided in addition to the first positioning element 7 and spaced apart from the first positioning element 7. The one structural element, which in the present case is the body 3, also has a third positioning element 12, which is spaced from the positioning elements 7 and 11 and is provided in addition to the positioning elements 7 and 11. The previous and present statements concerning the positioning element 11 may be readily transferred to the positioning element 12, and vice versa. The other structural element, which in the present case is the spring element and/or damper element 2, has a receiver 13 (FIG. 6) which is assigned to the positioning element 11 and provided in addition to the recess 9, and in which the second positioning element 11 engages, in particular such that a conical, second outer circumferential casing surface 14 of the second positioning element 11 is supported, in particular directly, in particular for example at least or exclusively in the vehicle longitudinal direction and/or in the vehicle height direction, on an inner circumferential casing surface 15—which delimits, in particular directly, the receiver 13—of the other structural element, in the present case the body 3. In the exemplary embodiment shown in the figure, the receiver 13 is a slot, which is formed for example elongate in the vehicle longitudinal direction. The one structural element, which in the present case is the spring element and/or damper element 2, also has a second receiver 16 which is assigned to the positioning element 12 and in which the positioning element 12 engages, in particular such that a conical, third outer circumferential casing surface 18 of the positioning element 12 is supported, in particular directly, in particular exclusively and here for example in the vehicle longitudinal direction and/or in the vehicle height direction, on a second inner circumferential casing surface 17—which delimits, in particular directly, the receiver 16—of the other structural element, in the present case the spring element and/or damper element 2. In the exemplary embodiment shown in the figure, it is provided that the receiver 16 is formed circular. In the exemplary embodiment shown in the figure, the one structural element is the body 3, wherein the other structural element is the spring element and/or damper element 2, in particular the support bearing 4, so that in the present case the support bearing 4 comprises the receivers 13 and 16 and hence the inner circumferential casing surfaces 15 and 17.

In a further exemplary embodiment, not shown in the figures, it is conceivable that the one structural element is the spring element and/or damper element 2, in particular the support bearing 4, and the other structural element is the body 3.

The respective positioning element 11, 12, in particular the respective conical casing surface 14, 18, is formed conically with respect to a second cone axis and hence arranged on at least a part of a respective theoretical second cone, which is also called the second cone and which is formed rotationally symmetrical with respect to the second cone axis. For example, the respective second cone axis runs obliquely or perpendicularly to the vehicle height direction, and hence preferably in the vehicle transverse direction of the motor vehicle.

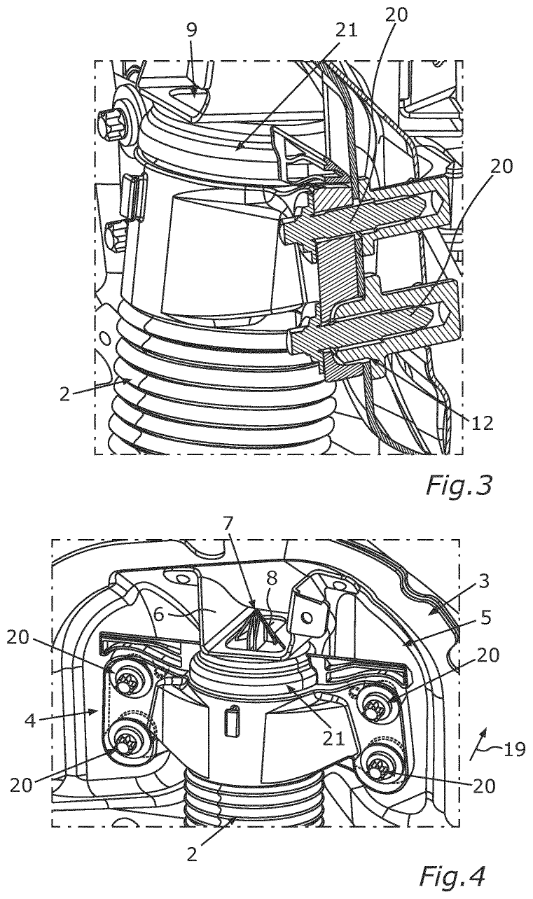

In the exemplary embodiment shown in the figures, the spring element and/or damper element 2—as can be seen particularly clearly from FIG. 3—is screwed to the body 3 along a screwing direction, illustrated by an arrow 19, and thereby fastened on the body 3. For this, screw elements 20 configured as bolts are provided, which pass through respective corresponding passage openings of the spring element and/or damper element 2, in particular the support bearing 4, and are screwed for example to corresponding further screw elements. The further screw elements are for example nuts, which may for example be connected, in particular welded, to the body 3 or be constituent parts of the body 3. The straight screwing direction (arrow 19) runs in the axial direction and hence in the longitudinal extent direction of the respective screw element 20. The respective screw element 20 is rotated, relative to the spring element and/or damper element 2 and relative to the body 3, about a respective screw axis coinciding with the screwing direction, and thereby the respective screw element 20 is screwed to the respective corresponding further screw element, and hence to the body 3, in order thereby to screw the spring element and/or damper element 2 to the body 3. In the present case, the screwing direction runs in the vehicle transverse direction, so that a particularly simple mounting, hence fastening, of the spring element and/or damper element 2 on the body 3 is conceivable. It is particularly clearly evident from FIGS. 3, 5 and 6, that the respective screw element 20 passes through the support bearing 4 and engages in the respective positioning element 11, 12. In particular, it is here conceivable that the respective screw element 20 is screwed to the respective positioning element 11, 12, in particular screwed into the respective positioning element 11, 12. Thus, for example, the respective positioning element 11, 12 is the respective further screw element, corresponding to the respective screw element 20. In particular, the respective screw element 20 passes through the respective receiver 13, 16.

The positioning element 7 is preferably made of a plastic. In the exemplary embodiment shown in the figure, the positioning element 7 is a constituent part of a cap 21 of the spring element and/or damper element 2, also called a centering cap or configured or functioning as a centering cap, wherein the cap 21 is formed from the above-mentioned plastic. The cap 21 is here formed separately from the support bearing 4 and is connected for example, in particular at least indirectly or directly, to the support bearing 4. For example, the support bearing 4 is made from a metal material. For example, because, for example, the receiver 13 is configured as a slot, the longitudinal extent direction of which runs in the vehicle longitudinal direction, by means of the receiver 13 and the associated positioning element 11, a tolerance compensation in the vehicle longitudinal direction can be realized. Furthermore, the region B2 is or functions as a rough catchment contour or a rough catchment region, wherein the region B1 functions as a fine catchment region or a fine catchment contour. In this way, the spring element and/or damper element 2 can be fastened on the body 3 in a fashion which is particularly favorable in terms of time and cost, and fastened particularly precisely relative to the body 3, in particular exclusively in a z movement, i.e., in or by a relative movement in the vehicle height direction between the body 3 and the spring element and/or damper element 2. The conical positioning element 7 functions as an overload protection and as a mounting aid for positioning the spring element and/or damper element 2 relative to the body 3. Thus, in comparison with conventional solutions, particularly small screws, which are hence favorable in terms of weight and installation space, can be used as the screw elements 20. Also, the positioning element 11 and/or 12 may be used as overload protection and as a mounting aid for positioning the spring element and/or damper element 2 relative to the body 3, so that screws which are particularly favorable in terms of weight, installation space and costs, can be used as the screw elements 20.

The conical, outer circumferential casing surface 8 is formed for example by at least one or more, in particular soft, wings of the positioning element 7. When the positioning element 7 is moved for example from or out of the region B2, in particular along the movement plane, into the region B1, the outer circumferential casing surface 8 thereby comes into—in particular direct—support contact with the first part region TB of the inner contour 10, and the wing or the positioning element 7 is deformed, in particular elastically. This deformation leads to advantageously low forces, in particular on a movement, in particular on a pushing, of the spring element and/or damper element 2 into its nominal position, also called the mounting position, in which the screw elements 20 are screwed and in particular tightened, in order thereby to establish the spring element and/or damper element 2 on the body 3.

A mounting process, also called marriage, is described below, in which the spring element and/or damper element 2 is fastened on the body 3. The body 3 is for example fixed, hence stationary. A vehicle axle, also called an axle, comprising the spring element and/or damper element 2, travels or is moved in for example a pure z movement, i.e., a movement running purely or exclusively in the vehicle height direction, relative to and in the direction of the body 3. The axle is suspended under its own weight, and the spring element and/or damper element is completely extended by its extension force, which in particular takes the form of a damper extension force. Thus, for example, the support bearing 4 is not in its desired nominal position. In conventional solutions, an aid is used to position the spring element and/or damper element 2, in particular the support bearing 4, relative to the body 3, in order then to be able to screw the support bearing 4 onto the body 3. By means of the fastening arrangement 1, now however such an additional aid can be avoided. For this, for example, during the marriage, a so-called rough joining is performed in which a relative movement is provoked in the vehicle height direction, between the body 3 and the spring element and/or damper element 2, in particular such that the positioning element 7 is moved into the region B2, in particular from bottom to top in the vehicle height direction. During this, for example, the support bearing 4 and/or the cap 21 slide over the body 3 and along the body 3. For this, the cap 21, made for example from the plastic, is pulled over at least one or more regions of the support bearing 4, made for example from aluminium, in order to act as protection against scratching of the, for example, already painted body 3. Thus it is conceivable that a direct sliding of the support bearing 4 as such over the body 3 is avoided, so that for example, on this relative movement, it is not the support bearing 4 but the cap 21 which slides over the body 3 and slides along the body 3. For this, the cap 21 and hence the spring element and/or damper element has at least one slide-over chamfer 22, which runs for example obliquely to the vehicle height direction, thus for example runs in a slide-over plane, which runs obliquely to the vehicle height direction. During the relative movement, the slide-over chamfer 22 slides—for example, in particular directly—over a corresponding face 32 of the body 3, in particular without the support bearing 4 coming into direct contact with the body 3. During the marriage, in particular during this relative movement between the spring element and/or damper element 2 and the body 3, the positioning element 7 is moved, in particular inserted, into the region B2, in particular from bottom to top in the vehicle height direction. Thus, so to speak, the region B2 as a counter-contour suspends the positioning element 7, functioning as a centering tip. For example, the spring element and/or damper element 2 is moved relative to the body 3 upwards in the vehicle height direction until the spring element and/or damper element 2, in particular the support bearing 4, with the cap 21, travels or is moved in the vehicle height direction onto a stop at a body-side counter-contour. Since, for example, the positioning element 7 can only be moved from the region B2 into the region B1 by the positioning element 7 being deformed, in particular elastically, an advantageously high but not excessively high force is required to move the positioning element 7 out of or from the region B2 into the region B1, and inwards in the vehicle transverse direction. Thus, for example, during this the relative movement, taking place in the vehicle height direction, between the spring element and/or damper element 2 and the body 3, it is avoided that the spring element and/or damper element 2, in particular the support bearing 4, moves inwards undesirably and excessively far in the vehicle transverse direction.

In particular, after the positioning element 7 has been moved, in particular inserted, into the region B2, from bottom to top in the vehicle height direction, the spring element and/or damper element 2 is moved relative to the body 3, in particular inwards in the vehicle transverse direction, such that the positioning element 7, in particular while it engages in the recess 9, is moved, in particular displaced, in the above-mentioned movement plane and hence in particular inwards in the vehicle transverse direction, and thus from the region B2 into the region B1. This is achieved, for example, by means of a screwing tool, by means of which the screw elements 20 are screwed. The screw element, for example, exerts a force acting in particular inwards in the vehicle transverse direction, and hence onto the spring element and/or damper element 2, in particular onto the support bearing 4, by means of which force the spring element and/or damper element 2 is moved relative to the body 3, such that the positioning element 7 is moved out of the region B2 into the region B1. As a result, the positioning elements 11 and 12 are moved into the corresponding receivers 13 and 16, so that, for example, the spring element and/or damper element 2 is also oriented, thus positioned, relative to the body 3 in the vehicle longitudinal direction. Finally, for example, the screw elements 20 are screwed, in particular tightened, by means of the screwing tool, whereby the spring element and/or damper element 2 is screwed via the support bearing 4 onto the body 3 and thus fastened on the body 3.

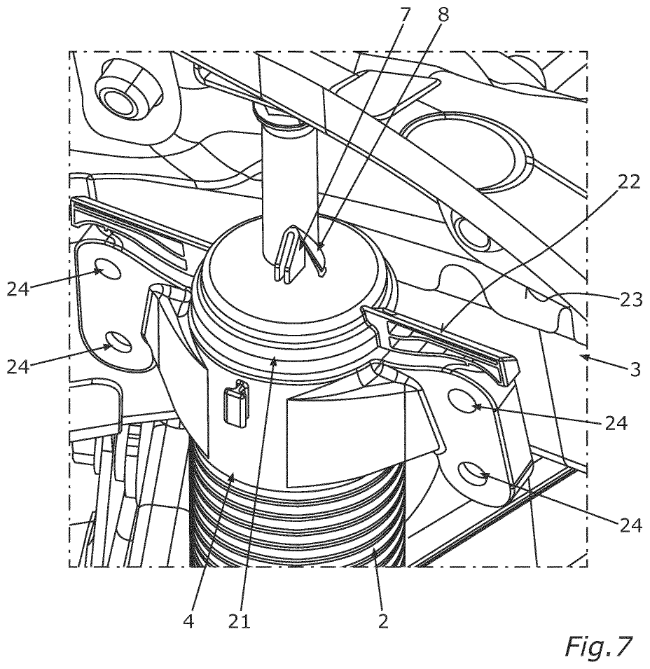

The passage openings of the support bearing 4, through which the screw elements 20 pass, can be seen in FIG. 7 where they are designated 24.

### List of Reference Characters

1 Fastening arrangement
2 Spring element and/or damper element
3 Body
4 Support bearing
5 Body element
6 Body element
7 Positioning element
8 Outer circumferential casing surface
9 Receiver
10 Inner contour
11 Positioning element
12 Positioning element
13 Receiver
14 Outer circumferential casing surface
15 Inner circumferential casing surface
16 Receiver
17 Inner circumferential casing surface
18 Outer circumferential casing surface
19 Arrow
20 Screw element
21 Cap
22 Slide-over chamfer
24 Passage opening
25 Double arrow
B1 First region
B2 Second region
TB First part region
TB2 Second part region

1.-10. (canceled)

11. A fastening arrangement on a body of a motor vehicle, comprising:
a spring element and/or a damper element, wherein the spring element and/or the damper element is fastened on the body;
wherein the spring element and/or the damper element has a positioning element which has an outer circumferential casing surface that widens from top to bottom in a height direction of the motor vehicle;
wherein the positioning element engages in a recess of a body element of the body and wherein the outer circumferential casing surface of the positioning element is supported at least on a part region of an inner contour of the recess.

12. The fastening arrangement according to claim 11, wherein the positioning element is deformed as a result of the outer circumferential casing surface being supported at least on the part region of the inner contour of the recess.

13. The fastening arrangement according to claim 12, wherein the recess has:
a first region, wherein the first region is at least partially delimited by the part region as a first part region of the inner contour of the recess; and
a second region, wherein the second region is delimited by a second part region of the inner contour of the recess which adjoins the first part region of the inner contour;
wherein the spring element and/or the damper element is detachable from the body and is movable relative to the body such that the positioning element, while the positioning element engages in the recess, is displaceable from the first region into the second region and then is movable out of the recess downwards in the height direction of the motor vehicle.

14. The fastening arrangement according claim 11:
wherein the spring element and/or the damper element is a first structural element and the body is a second structural element;
wherein one of the first and second structural elements has an outer circumferential, conical second positioning element which is provided in addition to the positioning element and spaced apart from the positioning element;
wherein the other of the first and second structural elements has a receiver in which the outer circumferential, conical second positioning element engages.

15. The fastening arrangement according to claim 14, wherein the outer circumferential, conical second positioning element is formed conically with respect to a cone axis which runs obliquely or perpendicularly to the height direction of the motor vehicle.

16. The fastening arrangement according to claim 11, wherein the spring element and/or the damper element is screwed to the body in a screwing direction.

17. The fastening arrangement according claim 16, wherein the screwing direction runs perpendicularly to a plane which runs parallel to the height direction of the motor vehicle.

18. The fastening arrangement according claim 16, wherein the screwing direction encloses an angle with the height direction of the motor vehicle and/or with a longitudinal direction of the motor vehicle and wherein the angle is greater than 70°.

19. The fastening arrangement according claim 16, wherein the screwing direction runs in a transverse direction of the motor vehicle.

20. The fastening arrangement according to claim 16:
wherein the spring element and/or the damper element is a first structural element and the body is a second structural element;
wherein one of the first and second structural elements has an outer circumferential, conical second positioning element which is provided in addition to the positioning element and spaced apart from the positioning element;
wherein the other of the first and second structural elements has a receiver in which the outer circumferential, conical second positioning element engages;
wherein the outer circumferential, conical second positioning element is formed conically with respect to a cone axis which runs obliquely or perpendicularly to the height direction of the motor vehicle;
wherein the cone axis runs parallel to the screwing direction or coincides with the screwing direction.

21. A method for fastening a spring element and/or a damper element to a body of a motor vehicle, comprising:
moving a positioning element, wherein the positioning element has an outer circumferential casing surface that widens from top to bottom in a height direction of the motor vehicle, into engagement with a recess of a body element of the body of the motor vehicle such that the outer circumferential casing surface is supported at least on a part region of an inner contour of the recess.

22. The method according to claim 21:
wherein the recess has:
a first region, wherein the first region is at least partially delimited by the part region as a first part region of the inner contour of the recess; and
a second region, wherein the second region is delimited by a second part region of the inner contour of the recess which adjoins the first part region of the inner contour;
wherein the positioning element initially moves from bottom to top in the height direction of the motor vehicle into the second region, and then, while the positioning element engages in the recess, is moved from the second region into the first region at least in a movement plane spanned by a transverse direction of the motor vehicle and a longitudinal direction of the motor vehicle such that the outer circumferential casing surface of the positioning element is brought into support contact with the first part region of the inner contour and the positioning element is deformed.
